(19) United States
(12) Patent Application Publication
(10) Pub. No.: US 2025/0368453 A1
(43) Pub. Date: Dec. 4, 2025

(54) METHODS AND APPARATUS FOR PLACEMENT OF AN OBJECT ON A CONVEYOR USING A ROBOTIC DEVICE

(71) Applicant: Boston Dynamics, Inc., Waltham, MA (US)

(72) Inventors: Matthew Turpin, Newton, MA (US); Michael Murphy, Carlisle, MA (US)

(21) Appl. No.: 18/679,632

(22) Filed: May 31, 2024

(51) Int. Cl. B65G 47/04; B65G 43/08; B65G 47/90

(52) U.S. Cl. CPC B65G 47/04; B65G 43/08; B65G 47/905; B65G 2203/0291; B65G 2203/041

(57) ABSTRACT

Methods and apparatus for determining a velocity of a conveyor associated with a mobile robot are provided. The method includes receiving first image data, the first image data including a first representation of a first object and a conveyor, the first image data captured at a first time, and determining by at least one hardware processor, a velocity of the conveyor based, at least in part, on the first representation of the first object in the first image data and a difference between the first time and a second time different from the first time.

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

Robots are typically configured to perform various tasks in an environment in which they are placed. Generally, these tasks include interacting with objects and/or the elements of the environment. Notably, robots are becoming popular in warehouse and logistics operations. Before the introduction of robots to such spaces, many operations were performed manually. For example, a person might manually unload boxes from a truck onto one end of a conveyor, and a second person at the opposite end of the conveyor might organize those boxes onto a pallet. The pallet may then be picked up by a forklift operated by a third person, who might drive to a storage area of the warehouse and drop the pallet for a fourth person to remove the individual boxes from the pallet and place them on shelves in the storage area. More recently, robotic solutions have been developed to automate many of these functions.

The speed at which a mobile robot can operate to perform a task such as unloading boxes from a truck onto a conveyor may be an important consideration when determining whether to use robots to perform such tasks. Several factors may limit the throughput or “pick rate” of a mobile robot tasked with unloading boxes or other objects from a truck onto a conveyor. One such factor is the velocity at which objects on the conveyor are moving away from the mobile robot, thereby providing a clear region to place a next object on the conveyor. In some instances, a mobile robot coupled to a conveyor may be configured to communicate with it to control aspects of the conveyor such as its position and/or operating speed. In other instances, a mobile robot coupled to a conveyor may not be configured to receive such communication, and the mobile robot may use sensors (e.g., image sensors) to determine whether a region of the conveyor is clear before placing a next object on the conveyor. In instances in which the conveyor is not operating as expected, it may be challenging for the mobile robot to determine the cause of the discrepancy so that it can be remediated to improve the pick rate of the mobile robot. As described herein, some embodiments of the present disclosure relate to techniques for automatically determining a velocity of one or more objects on a conveyor based on image data that includes a state of the one or more objects over time. Determining the state of one or more objects on the conveyor over time may enable the mobile robot to take appropriate corrective actions when issues with the conveyor velocity are detected and to ensure that the mobile robot is able to place new objects on the conveyor in a safe and efficient manner at a desired speed.

In some embodiments, the invention features a method. The method includes receiving first image data, the first image data including a first representation of a first object and a conveyor, the first image data captured at a first time, and determining by at least one hardware processor, a velocity of the conveyor based, at least in part, on the first representation of the first object in the first image data and a difference between the first time and a second time different from the first time.

In one aspect, the second time is a time at which the first object was placed on the conveyor. In another aspect, the method further includes receiving second image data, the second image data including a second representation of the first object and the conveyor, the second image data captured at the second time, wherein determining the velocity of the conveyor is further based, at least in part, on the second representation of the first object in the second image data.

In another aspect, the first image data includes first 2D image data and first time-of-flight data, and the second image data includes second 2D image data and second time-of-flight data. In another aspect, the method further includes processing the first 2D image data to identify a first mask for the first representation of the first object, determining a first 3D geometry of the first object based on the first mask and the first time-of-flight data, processing the second 2D image data to identify a second mask for the second representation of the first object, and determining a second 3D geometry of the first object based on the second mask and the second time-of-flight data, and determining a velocity of the conveyor based, at least in part, on the first representation of the first object in the first image data, the second representation of the first object in the second image data, and a difference between the first time and the second time comprises determining the velocity of the conveyor based on the first 3D geometry of the first object and the second 3D geometry of the first object.

In another aspect, the method further includes determining based, at least in part, on the first image data, a first location of the first object at the first time, determining based, at least in part, on the second image data, a second location of the first object at the second time, and determining the velocity of the conveyor based, at least in part, on the first location, the second location and the difference between the first time and the second time. In another aspect, the first image data and the second image data are captured from multiple cameras located at different distances from the first object at the first time. In another aspect, the first image data and the second image data are captured from a same camera. In another aspect, the first image data is captured from a first camera and the second image data is captured from a second camera having a different field of view from the first camera. In another aspect, an arm of a mobile robot coupled to the conveyor is not included in the first image data or the second image data. In another aspect, the first image data further includes a first representation of a second object, and determining the velocity of the conveyor is further based, at least in part, on the first representation of the second object in the first image data.

In another aspect, the method further includes controlling a mobile robot coupled to the conveyor to perform an action based, at least in part, on the velocity of the conveyor. In another aspect, controlling a mobile robot to perform an action comprises controlling the mobile robot to adjust an operation speed of the mobile robot. In another aspect, controlling the mobile robot to adjust an operation speed of the mobile robot comprises controlling the mobile robot to adjust a rate at which the mobile robot is placing objects on the conveyor. In another aspect, controlling the mobile robot to adjust an operation speed of the mobile robot comprises halting operation of an arm of the mobile robot when it is determined that the velocity of the conveyor is zero. In another aspect, controlling a mobile robot to perform an action comprises controlling the mobile robot to place an object at a particular place on the conveyor. In another aspect, controlling a mobile robot to perform an action comprises controlling the mobile robot to place an object on the conveyor using a particular orientation. In another aspect, controlling a mobile robot to perform an action comprises controlling the mobile robot to grasp a particular object. In another aspect, controlling a mobile robot to perform an action comprises controlling the mobile robot to output an indication of the velocity of the conveyor. In another aspect, controlling a mobile robot to perform an action comprises controlling the mobile robot to interact with the first object. In another aspect, the first object is a box located on the conveyor.

In some embodiments, the invention features a mobile robot. The mobile robot includes at least one hardware processor configured to receive first image data, the first image data including a first representation of a first object and a conveyor, the first image data captured at a first time, and determine a velocity of the conveyor based, at least in part, on the first representation of the first object in the first image data and a difference between the first time and a second time different from the first time.

In one aspect, the method further includes one or more camera modules and a controller configured to control the one or more camera modules to capture the first image data. In another aspect, the second time is a time at which the first object was placed on the conveyor. In another aspect, the at least one hardware processor is further configured to receive second image data, the second image data including a second representation of the first object and the conveyor, the second image data captured at the second time, and determining the velocity of the conveyor is further based, at least in part, on the second representation of the first object in the second image data.

In another aspect, the first image data includes first 2D image data and first time-of-flight data, and the second image data includes second 2D image data and second time-of-flight data. In another aspect, the at least one hardware processor is further configured to process the first 2D image data to identify a first mask for the first representation of the first object, determine a first 3D geometry of the first object based on the first mask and the first time-of-flight data, process the second 2D image data to identify a second mask for the second representation of the first object, and determine a second 3D geometry of the first object based on the second mask and the second time-of-flight data, wherein determining a velocity of the conveyor based, at least in part, on the first representation of the first object in the first image data, the second representation of the first object in the second image data, and a difference between the first time and the second time comprises determining the velocity of the conveyor based on the first 3D geometry of the first object and the second 3D geometry of the first object.

In another aspect, the at least one hardware processor is further configured to determine based, at least in part, on the first image data, a first location of the first object at the first time, determine based, at least in part, on the second image data, a second location of the first object at the second time, and determine the velocity of the conveyor based, at least in part, on the first location, the second location and the difference between the first time and the second time.

In another aspect, the mobile robot further includes one or more camera modules and a controller configured to control the one or more camera modules to capture the first image data and the second image data. In another aspect, the one or more camera modules includes a first camera module and a second camera module, and the mobile robot further includes a perception mast, wherein the first camera module is arranged below a second camera module on the perception mast. In another aspect, the first image data further includes a first representation of a second object, and the at least one hardware processor is configured to determine the velocity of the conveyor is further based, at least in part, on the first representation of the second object in the first image data.

In another aspect, the mobile robot further includes a controller configured to control the mobile robot to perform an action based, at least in part, on the velocity of the conveyor. In another aspect, the controller is configured to control the mobile robot to perform an action by controlling the mobile robot to adjust an operation speed of the mobile robot. In another aspect, controlling the mobile robot to adjust an operation speed of the mobile robot comprises controlling the mobile robot to adjust a rate at which the mobile robot is placing objects on the conveyor. In another aspect, controlling the mobile robot to adjust an operation speed of the mobile robot comprises halting operation of an arm of the mobile robot when it is determined that the velocity of the conveyor is zero. In another aspect, the controller is configured to control the mobile robot to perform an action by controlling the mobile robot to place an object at a particular place on the conveyor. In another aspect, the controller is configured to control the mobile robot to perform an action by controlling the mobile robot to place an object on the conveyor using a particular orientation. In another aspect, controller is configured to control the mobile robot to perform an action by controlling the mobile robot to grasp a particular object. In another aspect, the controller is configured to control the mobile robot to perform an action by controlling the mobile robot to output an indication of the velocity of the conveyor. In another aspect, the controller is configured to control the mobile robot to perform an action by controlling the mobile robot to interact with the first object. In another aspect, the first object is a box located on the conveyor.

In some embodiments, the invention features a method. The method includes determining based on a state of one or more objects on a conveyor at a first time, a region on the conveyor that will be clear at a second time after the first time and controlling a mobile robot to place an object within the region on the conveyor at the second time.

In one aspect, controlling a mobile robot to place the object within the region on the conveyor at the second time comprises controlling the mobile robot to adjust an operation speed of the mobile robot such that the mobile robot is controlled to place the object on the conveyor at the second time. In another aspect, controlling a mobile robot to place the object within the region on the conveyor at the second time comprises controlling the mobile robot to place the object within a particular portion of the region. In another aspect, controlling a mobile robot to place the object within the region on the conveyor at the second time comprises controlling the mobile robot to place the object using a particular orientation. In another aspect, controlling a mobile robot to place the object within the region on the conveyor at the second time comprises controlling the mobile robot to select a particular object based on a size of the region, and controlling the mobile robot to place the particular object within the region on the conveyor at the second time. In another aspect, the object is a box.

In some embodiments, the invention features a mobile robot. The mobile robot includes at least one hardware processor and a controller. The at least one hardware processor is configured to determine based on a state of one or more objects on a conveyor at a first time, a region on the conveyor that will be clear at a second time after the first time. The controller is configured to control the mobile robot to place an object within the region on the conveyor at the second time.

In one aspect, the controller is configured to control the mobile robot to place the object within the region on the conveyor at the second time by controlling the mobile robot to adjust an operation speed of the mobile robot such that the mobile robot is controlled to place the object on the conveyor at the second time. In another aspect, the controller is configured to control the mobile robot to place the object within the region on the conveyor at the second time by controlling the mobile robot to place the object within a particular portion of the region. In another aspect, the controller is configured to control a mobile robot to place the object within the region on the conveyor at the second time by controlling the mobile robot to place the object using a particular orientation. In another aspect, the controller is configured to control a mobile robot to place the object within the region on the conveyor at the second time by controlling the mobile robot to select a particular object based on a size of the region and controlling the mobile robot to place the particular object within the region on the conveyor at the second time. In another aspect, the object is a box.

In some embodiments, the invention features a method. The method includes determining, using image data, whether a rate of travel of one or more objects along a conveyor coupled to a mobile robot is less than an expected rate, determining, based on the image data, a state of the one or more objects on the conveyor when it is determined that the rate of travel of the one or more objects along the conveyor coupled to the mobile robot is less than the expected rate, and controlling an operation of the mobile robot based, at least in part, on the state of the one or more objects on the conveyor. In another aspect, determining, using image data, that a rate of travel of one or more objects along a conveyor coupled to a mobile robot is less than an expected rate comprises determining that the conveyor is not moving at a predicted speed. In another aspect, determining a state of the one or more objects on the conveyor comprises determining that an object is stuck at a location on the conveyor. In another aspect, determining a state of the one or more objects on the conveyor comprises determining that a set of objects on the conveyor are separated with small or no gaps between the objects in the set. In another aspect, determining that a set of objects on the conveyor are separated with small or no gaps between the objects in the set comprises processing the image data with at least one model configured to output a set of masks associated with the set of objects, and determining that a set of objects on the conveyor are separated with small or no gaps between the objects in the set when spatially adjacent masks in the set of masks include contiguous pixels joining the spatially adjacent masks. In another aspect, the one or more objects are one or more boxes.

In some embodiments, the invention features a mobile robot. The mobile robot includes at least one hardware processor and a controller. The at least one hardware processor is configured to determine, using image data, whether a rate of travel of one or more objects along a conveyor coupled to a mobile robot is less than an expected rate, and determine, based on the image data, a state of the one or more objects on the conveyor when it is determined that the rate of travel of the one or more objects along the conveyor coupled to the mobile robot is less than the expected rate. The controller is configured to control an operation of the mobile robot based, at least in part, on the state of the one or more objects on the conveyor.

In one aspect, determining whether the rate of travel of the one or more objects along a conveyor coupled to a mobile robot is less than an expected rate comprises determining that the conveyor is not moving at a predicted speed. In another aspect, determining a state of the one or more objects on the conveyor comprises determining that an object is stuck at a location on the conveyor. In another aspect, determining a state of the one or more objects on the conveyor comprises determining that a set of objects on the conveyor are separated with small or no gaps between the objects in the set. In another aspect, determining that a set of objects on the conveyor are separated with small or no gaps between the objects in the set comprises processing the image data with at least one model configured to output a set of masks associated with the set of objects, and determining that a set of objects on the conveyor are separated with small or no gaps between the objects in the set when spatially adjacent masks in the set of masks include contiguous pixels joining the spatially adjacent masks. In another aspect, the one or more objects comprise one or more boxes.

In some embodiments, the invention features a non-transitory computer-readable medium including a plurality of processor executable instructions stored thereon that, when executed by at least one hardware processor, perform any of the methods described herein.

### BRIEF DESCRIPTION OF DRAWINGS

The advantages of the invention, together with further advantages, may be better understood by referring to the following description taken in conjunction with the accompanying drawings. The drawings are not necessarily to scale, and emphasis is instead generally placed upon illustrating the principles of the invention.

FIGS. 1A and 1B are perspective views of a robot, according to an illustrative embodiment of the invention.

FIG. 2A depicts robots performing different tasks within a warehouse environment, according to an illustrative embodiment of the invention.

FIG. 2B depicts a robot unloading boxes from a truck and placing them on a conveyor belt, according to an illustrative embodiment of the invention.

FIG. 2C depicts a robot performing an order building task in which the robot places boxes onto a pallet, according to an illustrative embodiment of the invention.

FIG. 3 is flowchart of a process for determining the velocity of a conveyor based on image data, according to an illustrative embodiment of the invention.

FIG. 4 is a flowchart of a process for controlling a mobile robot to determine whether a region of a conveyor will be clear to place an object at a future time, according to an illustrative embodiment of the invention.

FIG. 5 is a flowchart of a process for controlling a mobile robot to perform an action when a rate of travel of one or more objects on a conveyor is slower than an expected rate, according to an illustrative embodiment of the invention.

FIGS. 6A-6C illustrate different scenarios in which a rate of travel of one or more objects on a conveyor may be slower than an expected rate, according to an illustrative embodiment of the invention.

FIG. 7 illustrates an example configuration of a robotic device, according to an illustrative embodiment of the invention.

### DETAILED DESCRIPTION

Some mobile robots may be configured to perform repetitive tasks such as unloading boxes or other objects from a truck onto a conveyor in a warehouse or other industrial environment. At least some of the value provided by operating robots in such environments may be derived from the fact that they can operate quickly, for relatively long periods of time, and/or without requiring frequent breaks. Although the mobile robot can control how fast it operates to effectively and efficiently move objects such as boxes, other factors outside of the robot's control, such as the velocity of the conveyor, defects with the conveyor that may cause boxes to become stuck, and how quickly downstream processes can remove boxes from the conveyor may reduce the pick rate of mobile robots. In situations where the mobile robot has determined that there is not a clear region to place a next box on the conveyor, the mobile robot may remain idle for a predetermined amount of time until human intervention takes to place to remedy the situation, thereby significantly reducing the robot's pick rate. The inventors have recognized and appreciated that a mobile robot may be configured to use onboard sensors (e.g., onboard camera modules) to predict whether a region will be clear on the conveyor at a future time to place a next object and to detect and/or diagnose possible issues with a conveyor and provide appropriate reactive solutions that may reduce downtime of the robot. To this end, some embodiments relate to techniques for assessing a state of one or more objects as they travel down a conveyor to inform the operation of the robot and implement appropriate actions when issues with the conveyor are detected.

Robots configured to operate in a warehouse or industrial environment are typically either be specialist robots (i.e., designed to perform a single task or a small number of related tasks) or generalist robots (i.e., designed to perform a wide variety of tasks). To date, both specialist and generalist warehouse robots have been associated with significant limitations.

For example, because a specialist robot may be designed to perform a single task (e.g., unloading boxes from a truck onto a conveyor belt), while such specialized robots may be efficient at performing their designated task, they may be unable to perform other related tasks. As a result, either a person or a separate robot (e.g., another specialist robot designed for a different task) may be needed to perform the next task(s) in the sequence. As such, a warehouse may need to invest in multiple specialized robots to perform a sequence of tasks, or may need to rely on a hybrid operation in which there are frequent robot-to-human or human-to-robot handoffs of objects.

In contrast, while a generalist robot may be designed to perform a wide variety of tasks (e.g., unloading, palletizing, transporting, depalletizing, and/or storing), such generalist robots may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible.

Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task.

In such systems, the mobile base and the manipulator may be regarded as effectively two separate robots that have been joined together. Accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while certain limitations arise from an engineering perspective, additional limitations must be imposed to comply with safety regulations. For example, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not threaten the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, a highly integrated mobile manipulator robot with system-level mechanical design and holistic control strategies between the manipulator and the mobile base may provide certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

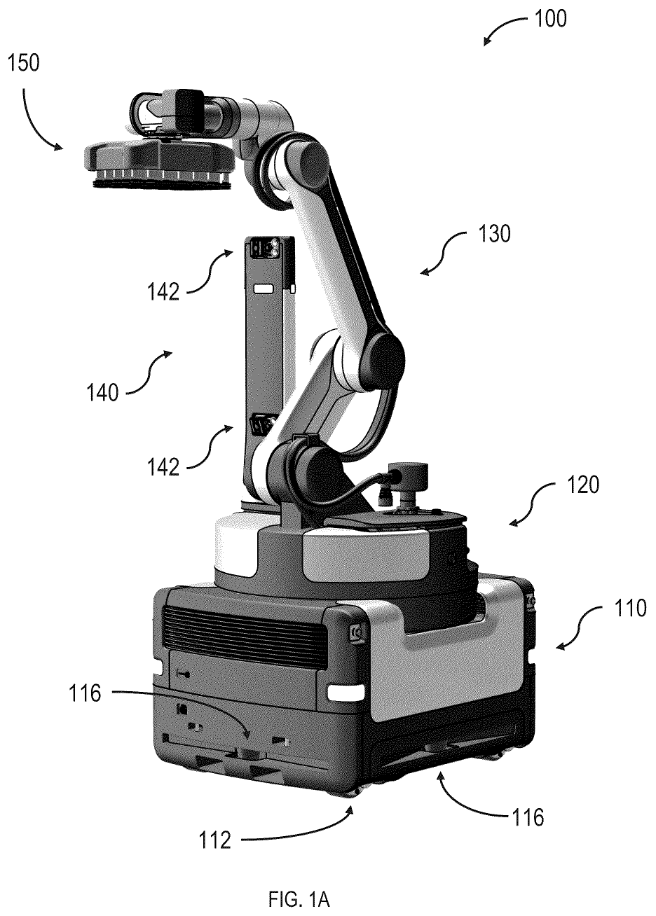

FIGS. 1A and 1B are perspective views of a robot 100, according to an illustrative embodiment of the invention. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

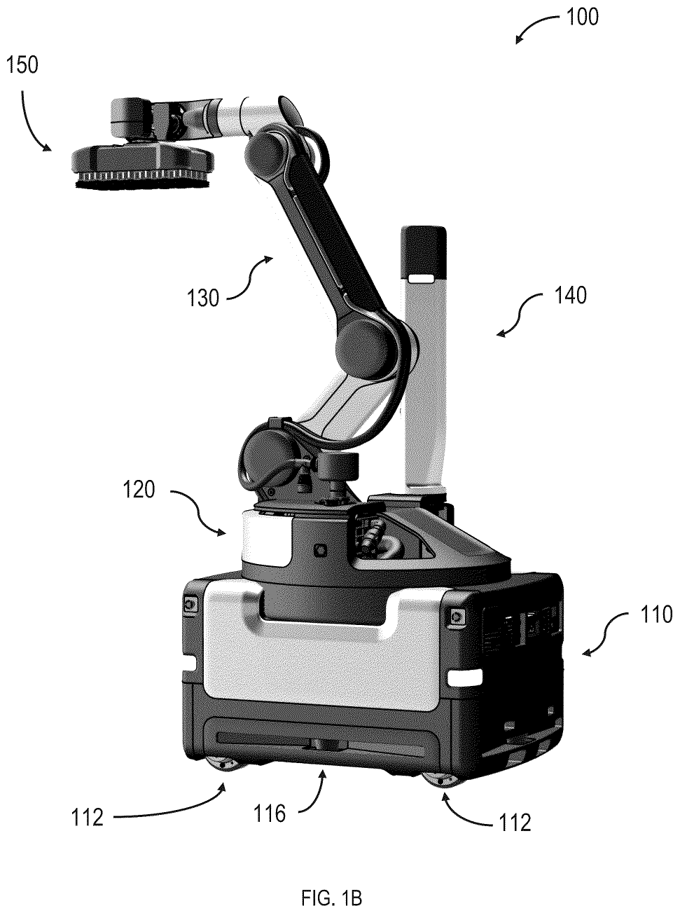

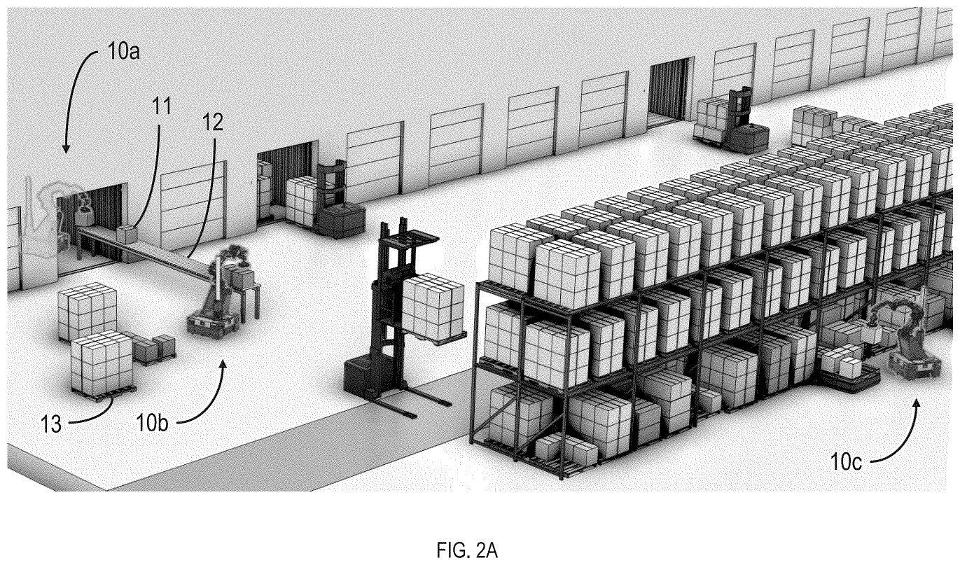

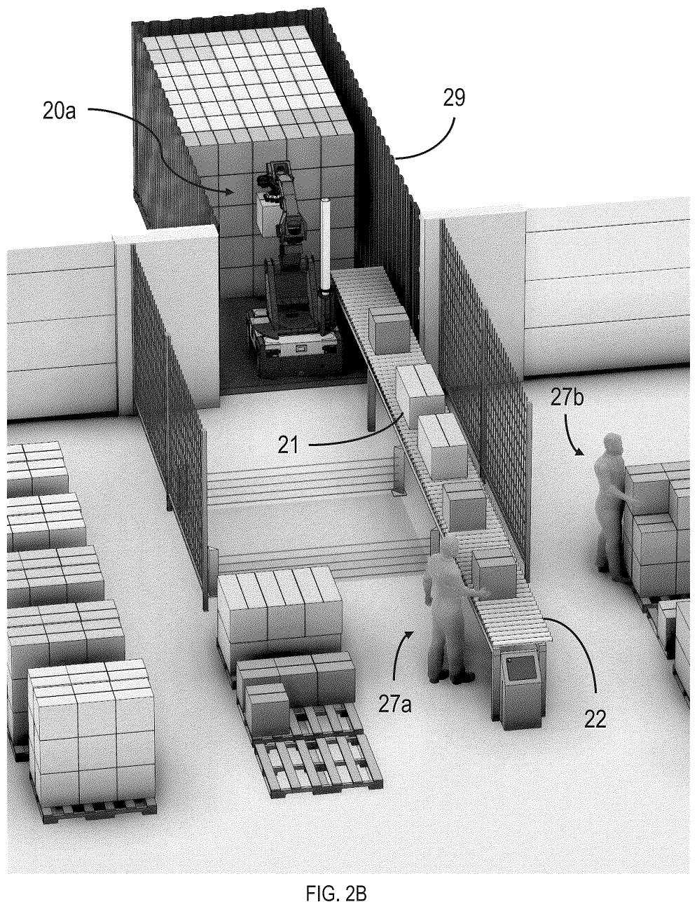

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). The robots 10a, 10b, and 10c can be different instances of the same robot or similar robots. Accordingly, the robots described herein may be understood as specialized multi-purpose robots, in that they are designed to perform specific tasks accurately and efficiently, but are not limited to only one or a small number of tasks.

FIG. 2B depicts a robot 20a unloading boxes 21 from a truck 29 and placing them on a conveyor belt 22. In this box picking application (as well as in other box picking applications), the robot 20a repetitiously picks a box, rotates, places the box, and rotates back to pick the next box. Although robot 20a of FIG. 2B is a different embodiment from robot 100 of FIGS. 1A and 1B, referring to the components of robot 100 identified in FIGS. 1A and 1B will case explanation of the operation of the robot 20a in FIG. 2B.

During operation, the perception mast of robot 20a (analogous to the perception mast 140 of robot 100 of FIGS. 1A and 1B) may be configured to rotate independently of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety field around the robot (e.g., into which humans are prevented from entering and/or which are associated with other safety controls, as explained in greater detail below).

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

The tasks depicted in FIGS. 2A-2C are only a few examples of applications in which an integrated mobile manipulator robot may be used, and the present disclosure is not limited to robots configured to perform only these specific tasks. For example, the robots described herein may be suited to perform tasks including, but not limited to: removing objects from a truck or container; placing objects on a conveyor belt; removing objects from a conveyor belt; organizing objects into a stack; organizing objects on a pallet; placing objects on a shelf; organizing objects on a shelf; removing objects from a shelf; picking objects from the top (e.g., performing a “top pick”); picking objects from a side (e.g., performing a “face pick”); coordinating with other mobile manipulator robots; coordinating with other warehouse robots (e.g., coordinating with AMRs); coordinating with humans; and many other tasks.

As described herein, mobile robots operating in a warehouse environment may be configured to perform pick and place operations where the mobile robot is tasked with unloading boxes or other objects from a truck or storage container onto a conveyor (e.g., a telescopic conveyor or an accordion conveyor). To improve the performance of pick and place operations (e.g., by increasing pick rate, by detecting stuck objects on the conveyor, etc.), the mobile robot may include one or more camera modules (e.g., camera modules 142 arranged on perception mast 140 shown in FIG. 1A) configured to capture an image of the conveyor behind the area in which the mobile robot is grasping a next box to be placed on the conveyor. The captured image may be used to check if a pre-defined region on the conveyor near the robot is clear to place the next box. If it is determined that the region is clear when the image is captured, the robot may determine that there will be sufficient space on the conveyor to avoid knocking any boxes off or placing a box on top of another box when the robot is ready to place the next box. If the pre-defined region is not clear when the image is captured, the robot may pause its pick and place operation and continue to take images of the region until it is clear or until a timeout is reached and an intervention is issued for a human to resolve any issues.

In order to maintain a high pick rate, the robot may be configured to make decisions about where to place a next box on the conveyor multiple seconds in advance of actually placing the box, particularly when an image used to determine a clear region for placement is taken well in advance of the placement operation. Although it may be desired to capture an image of the conveyor during or immediately before placing a box on the conveyor to ensure that a region of the conveyor is clear for placement, such a region may be occluded by the arm and/or the grasped box at that time. Additionally, the one or more camera modules of the mobile robot may be used for other purposes at that time (e.g., to capture an image of the stack of boxes in a truck to enable the robot sufficient time to plan for the next box grasp). As described above, one or more camera modules may be used to capture an image of the conveyor in one direction while the arm of the robot is grasping a next box to place in a different (e.g., opposite) direction. Some robots may implement a simple delay model by assuming a constant pre-defined velocity of boxes on the conveyor and a constant placement time of each box. Although such a simple delay model may work well when the conveyor and downstream operations are operating as expected, disruptions in the expected behavior of the conveyor may result in substantial downtime of the robot while it is waiting for the placement region on the conveyor to clear (e.g., possibly until the timeout period expires and human intervention is requested). Some embodiments are directed to detecting a current velocity of a conveyor and adjusting behavior of the mobile robot accordingly.

Some conveyors that may be used in combination with a mobile robot to perform pick and place operations may have speed selectors that may be manually set by a human operator. In some situations, the speed selector may be set at a speed that is less than the maximum speed possible for the conveyor. For instance, the speed of the conveyor may be set to provide a human unloading boxes from one end of the conveyor onto a pallet sufficient time to perform the unloading as boxes are placed on the conveyor at the other end by the mobile robot. In another example, a human operator may inadvertently set the speed of the conveyor slower than desired prior to initiating the pick and place operation with the mobile robot. When the conveyor speed is set too slowly, the robot can end up placing boxes too close to and/or on top of previously placed boxes. The inventors have recognized and appreciated that rather than assuming a constant velocity of boxes on the conveyor, it may be advantageous to determine a velocity of the conveyor by assessing the movement of boxes (or other objects) on the conveyor over time as they move away from the robot after being placed. By estimating the velocity of the conveyor in this way the behavior of the robot may be more closely matched to the velocity of the conveyor to improve the pick rate of the robot by picking and placing objects as fast as possible without knocking into previously placed objects.

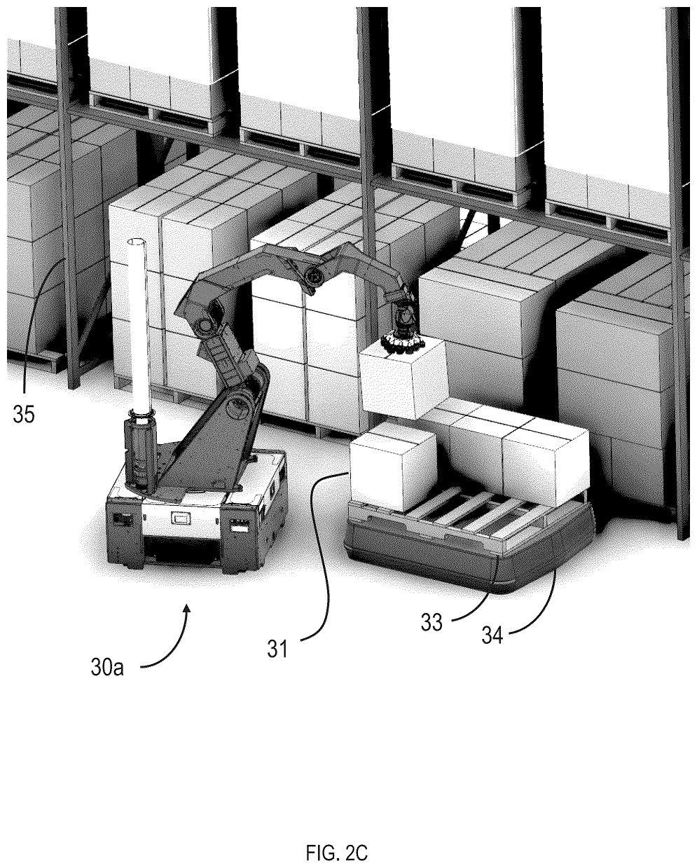

FIG. 3 shows a flowchart of a process 300 for determining the velocity of a conveyor in accordance with some embodiments. Process 300 begins in act 310, where first image data including the conveyor and a representation of a first object placed on the conveyor captured at a first time is received. For instance, as described above, in some embodiments a mobile robot may be configured to capture a single image of the conveyor while the robot is executing a pick of a next object to be placed on the conveyor. The single image of the conveyor may include a representation of a previously placed object that has moved some distance away from the mobile robot after placement.

Process 300 may then proceed to act 312, where the velocity of one or more objects on the conveyor may be determined based, at least in part, on the first object in the first image data and a difference between the first time (e.g., the time when the first image data was captured) and a second time different from the first time. For example, the second time may be the time when the object included in the first image data was previously placed by the mobile robot on the conveyor. The first image data may be processed (e.g., using a trained machine learning model or other image processing technique) to identify an object (e.g., the closest object representing the most recently placed object) in the image data. For example, a trained machine learning model may be used to segment a 2D image (e.g., a RGB image, a grayscale image) included in the first image data to determine which pixels in the 2D image correspond to an object of interest (e.g., a box) and which pixels in the 2D image do not correspond to the object of interest. The output of the trained machine learning model may be a mask identifying all of the “object” pixels. The first image data may also include time-of-flight data, which may be used to estimate a distance from the closest face of the closest object to the mobile robot to determine the current location of that object in the image relative to the camera module. For instance, all pixels identified as “object” pixels may be mapped to the time-of-flight data to determine a 3D geometry of the object on the conveyor. Because the robot previously placed the first object on the conveyor at a particular location on the conveyor (e.g., a particular distance from the robot's camera module) and at a particular time, the velocity of the object along the conveyor can be estimated based on the difference between the current time (e.g., the first time), and the placement time (e.g., the second time) and a difference between the current location as observed in the first image data and the location at which the object was previously placed on the conveyor.

In some embodiments, rather than capturing single image data of the conveyor during a pick operation, multiple image data may be captured and used to determine the velocity of the conveyor. For example, multiple image data may be captured using the same camera module or different camera modules having different fields of view. The different camera modules may be arranged at the same or different distance from an object located on the conveyor. When captured in quick succession, a comparison of the location of the object based on the multiple image data may be used to determine the local or “instantaneous” velocity of the box along the conveyor, and accordingly, a conveyor velocity estimate. In such embodiments, process 300 may include an additional act of receiving second image data including a representation of the first object and the conveyor, with the second image data being captured at the second time. The velocity of one or more objects on the conveyor may be determined in act 312 further based on the representation of the first object in the second image data, with the difference between the first time and the second time being represented as the difference in time between capturing the first and second image data. Unlike the single image data technique described above in which the timing of the previous placement and the image data capture is fixed, when capturing multiple images, the timing between the two image data captures can be adjusted to space apart the two image captures in time as much as is desired to obtain the local velocity of the object(s) on the conveyor.

As described herein, some mobile robots may include a perception mast (or other structure) that includes multiple camera modules. In the example robot shown in FIGS. 1A and 1B, the mobile robot includes an upper camera module and a lower camera module (e.g., each of which may include a 2D image sensor such as an RGB sensor) and a distance sensor (e.g., a time-of-flight camera), that together can be used to create a 3D geometry of the object). In some embodiments, the first image data and the second image data may be captured by the upper and lower camera modules, respectively, with the second image data capture being delayed from the first image data capture by a small amount (e.g., 50 ms, 100 ms, 200 ms, etc.) between the two image captures. Due to the delay between the two image data captures, the object will have traveled a short distance along the conveyor (e.g., 5 cm, 10 cm, 20 cm, etc.) depending on the velocity of the conveyor. Accordingly, the velocity of the object(s) on the conveyor may be determined in act 312 based on the distance the object has traveled down the conveyor in the two image data sets and the delay between the two image data captures.

In some embodiments in which multiple images are captured, multiple objects may be present in each of the multiple images (e.g., an object in the foreground of the image and an object in the background of the image). In some embodiments, a location of each of the multiple objects in the images may be determined and used to determine the velocity of the conveyor in act 312 of process 300. By determining the velocity of the conveyor using multiple objects, the accuracy of the conveyor velocity determination may be improved.

In some embodiments, the velocity of the conveyor may be determined in act 312 using a combination of velocity estimation techniques. For example, multiple images may be captured (e.g., from an upper camera module and a lower camera module on a perception mast) during each pick cycle. The multiple images captured at each pick cycle may be used to determine a local velocity of an object on the conveyor (e.g., over a short distance) and single images captured at each pick cycle may be used to determine the velocity of the object on the conveyor over a longer distance. The conveyor velocity estimates may be combined in any suitable way (e.g., using a filter with the same or different weights applied to the output of each of the estimation techniques) to determine the velocity of the object(s) on the conveyor in act 312 of process 300.

In some embodiments, the velocity of the object(s) on the conveyor determined in act 312 of process 300 may be used when determining how to control an operation of the mobile robot configured to place objects on the conveyor. For instance, if it is determined that the conveyor is moving slower than expected, the arm trajectory of the mobile robot may be slowed down based on the conveyor velocity such that newly placed objects do not knock previously placed objects off of the conveyor. If the conveyor speed is increased (e.g., due to human intervention or by sending a communication command from the mobile robot to the conveyor), the planning trajectory of the arm of the robot may be sped up over time to increase the pick rate of the robot when the velocity of the conveyor can support the increased pick rate. In some embodiments, it may be determined in act 312 that the velocity of the object(s) on the conveyor is zero, which may indicate that the conveyor is not operating or that an object has become stuck on the conveyor (e.g., due to a broken roller, a box becoming wedged on the edge of a conveyor, etc.). In such instances, the robot may be controlled to halt operation of the arm of the robot until an intervention can be performed to address the issue. In some embodiments, the intervention may include outputting an indication of the conveyor fault to a human user who can address the issue. In some embodiments, the intervention may include controlling the robot to attempt to automatically address the issue. For example, the robot may be controlled to nudge the stuck box with another object in its gripper or with the gripper itself in an attempt to dislodge the stuck object.

In some embodiments, information about the velocity of the object(s) on the conveyor may be used to adjust the planned placement of an object on the conveyor. For instance, if the object(s) on the conveyor is moving slower than expected, objects may be placed in a staggered position across the width of the conveyor in an attempt to maintain a faster pick rate than could be achieved if consecutively placed objects were placed behind each other inline along the conveyor travel direction.

As described herein, in some embodiments, an improved pick rate can be achieved by capturing one or more images of a state of object(s) on a conveyor well in advance (e.g., seconds in advance) of placing a next object on the conveyor. The inventors have recognized and appreciated that after determining an expected clear region on the conveyor where a next box may be placed and a velocity of the conveyor, that information can be used to plan for placement of the next box on the conveyor. For instance, an assumption can be made that based on the determined conveyor velocity, the region will keep clearing in the time that the robot will take to move the object from its pick location to a location over the conveyor prior to the place. Information about the velocity of the object(s) on the conveyor may be used to automatically adjust the planning process (e.g., by slowing down or speeding up arm motion as suitable for the conveyor velocity) such that objects are placed in the clearing region with enough of a gap to the previously placed object. By automatically adjusting the planned speed of a subsequent movement operation of the arm of the mobile robot to match the speed of the conveyor, the robot may be configured to adapt to changing conditions that may reduce human interventions, increase the productive time of the robot, and/or improve the energy efficiency of the robot operation.

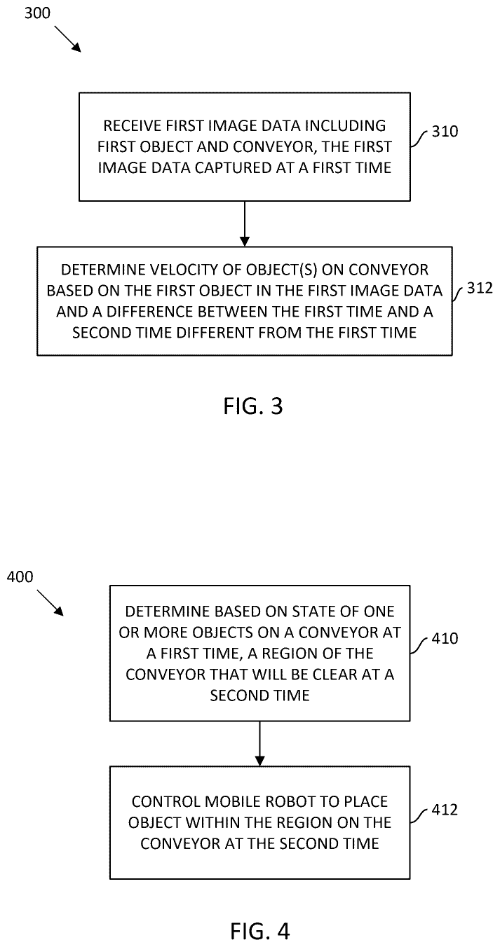

FIG. 4 illustrates a process 400 for adapting the operation of a mobile robot based on a state of one or more objects on a conveyor in accordance with some embodiments. Process 400 begins in act 410, where based on a state of one or more objects on a conveyor at a first time, a region that will be clear at a second time may be determined. For instance, if the closest object on the conveyor to the mobile robot at the first time is 0.5 m away from the mobile robot and the conveyor is moving at a rate of 0.5 m/s, it can be determined that a region of 1.5 m along the conveyor will be clear at a second time that is 2 seconds after the first time. As an example, assuming that the mobile robot may not want to place the next object any closer than 0.25 m from the robot and a minimum of 0.25 m gap should be left between placed objects, a placement region of 1 m may be determined to be expected at the second time. Process 400 may then proceed to act 412, where the mobile robot may be controlled to place the next object within the region at the second time. For instance, assuming that the object to be placed has a longest dimension of 1 m or less, the object may be placed within the expected 1 m clear region. If the object to be placed has a longer dimension than 1 m, the robot may be controlled to allow for the previously placed object to travel farther down the conveyor to provide a sufficient gap for placement of the next object.

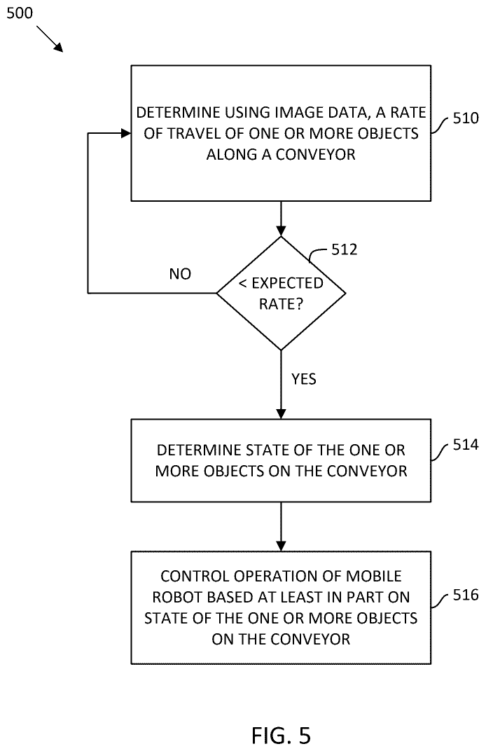

When one or more objects are determined to be traveling slower down the conveyor than expected, it may be beneficial to determine the reason for the discrepancy to determine an appropriate intervention for addressing the issue. For example, in some instances, the mobile robot itself may be able to address the issue by nudging a stuck box, which may not require human intervention or waiting until a timeout period has elapsed, thereby increasing the pick rate of the robot. FIG. 5 is a flowchart of a process 500 for controlling a mobile robot based on a state of one or more “slow” moving objects on a conveyor in accordance with some embodiments. Process 500 begins in act 510, where a rate of travel of one or more objects along a conveyor is determined. For example, any of the techniques described herein for determining a velocity of a conveyor by tracking a location of one or more objects on the conveyor over time based on sensed data may be used to determine a rate of travel of the one or more objects. Process 500 then proceeds to act 512, where it is determined whether the determined rate of travel is less than the expected rate of travel (possibly with some buffer to account for measurement error). If it is determined in act 512 that the determined rate of travel is not less than the expected rate, process 500 returns to act 510, where the rate of travel of one or more objects is again determined (e.g., after some amount of time, such as when the next image is captured in the next pick cycle).

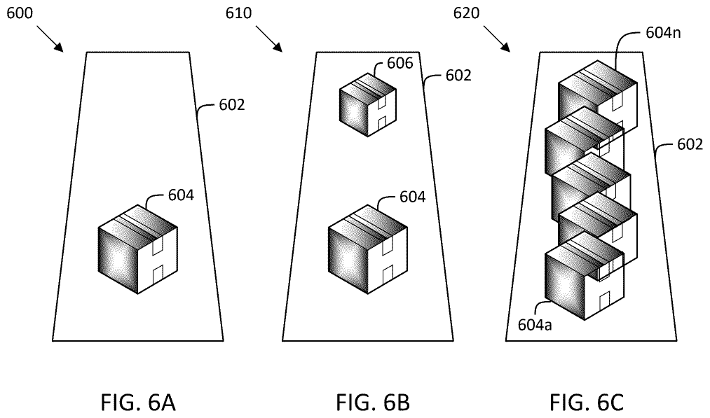

If it is determined in act 512 that the determined rate of travel is less than the expected rate, process 500 proceeds to act 514, where a state of the one or more objects on the conveyor is determined. FIGS. 6A-6C schematically illustrate scenarios for different states of one or more objects on a conveyor in accordance with some embodiments. FIG. 6A shows a scenario 600 in which a single box 604 has zero velocity along conveyor 602 with no other boxes behind it on the conveyor. In some situations, when there is a single box with zero velocity and no other boxes behind it on the conveyor, it is typically an indication that the box 604 is stuck on the conveyor 602. For instance, the rollers under box 604 may not be rotating, the box 604 may be wedged into the rollers, the box 604 may be stuck on the edge of a telescopic conveyor, etc.

FIG. 6B shows a scenario 610 in which a first box 604 and a second box 606 are observed on conveyor 602, with movement of the boxes having a lower velocity than expected. In scenario 610, the existence of gaps between the box 604 and box 606 may signify that the conveyor is simply set to a speed that is lower than it could or should be to increase the pick rate of the robot, while still leaving a suitable gap between boxes.

FIG. 6C shows a scenario 620, in which multiple boxes 604a . . . 604n have backed up all the way to the location on the conveyor 602 where the mobile robot is configured to place boxes, leaving no clear region to place a next box. In scenario 620, a low or no velocity of the boxes 604a . . . 604n may be detected with little or no gap between the boxes. In some embodiments, the scenario 620 may be determined based on image data by detecting overlapping or contiguous pixels for masks output from a model (e.g., a trained machine learning model) used to segment the image data into “box” and “not box” pixels.

Returning to process 500, after the state of the one or more objects on the conveyor is determined in act 514, process 500 proceeds to act 516, where an operation of the mobile robot is controlled based at least in part on the state of the one or more objects on the conveyor. For instance, whether the state of the one or more objects on the conveyor is represented by one of scenarios 600, 610, 620 or some other scenario, the mobile robot may be controlled to take different actions in an attempt to remedy the issue. In the example scenario 600 shown in FIG. 6A, the box 604 is likely stuck and is unlikely to clear without some intervention. If the robot was configured to continue monitoring the conveyor until the region including box 604 cleared or a timeout period expired, the robot would unnecessarily wait the entire duration of the timeout period prior to taking action. By contrast, in some embodiments, a stuck box 604 as shown in scenario 600 can be identified quickly and the robot may be controlled to perform an action such as nudging the stuck box and/or outputting an indication to a human worker to clear the stuck box 604 without having to wait the entire timeout period. In the example scenario 610 shown in FIG. 6B, the conveyor is not moving at the expected speed, and an indication may be output to a human worker to increase the speed of conveyor to improve pick speed. In the example scenario 620 shown in FIG. 6C, the conveyor has backed up with boxes all the way to the mobile robot. In such a scenario, the robot may be controlled to halt operation and simply wait for the conveyor to clear. In some embodiments, the robot may additionally be controlled to output an indication to a human worker that the conveyor is backed up, and they may consider reducing the speed of the conveyor if downstream operations are unable to keep up with the pick rate of the mobile robot.

Some examples of how the robot may be controlled based on the determined state of one or more objects on a conveyor have been described. Additional examples of how a robot may be controlled include, but are not limited to, controlling the robot to place objects in a different area of the conveyor (e.g., not in the middle of the conveyor), selecting how many objects to grasp in a pick and place operation (e.g., picking multiple objects at once), re-picking and placing stuck or fallen objects, selecting how to pick objects (e.g., pick more challenging boxes when the conveyor is backed up and will need time to clear), controlling the robot to place a currently picked box on the floor while waiting for the conveyor to clear, controlling the robot to rescan the conveyor to detect whether the issue has been resolved, controlling the robot to perform additional sensor and/or rearranging of the remaining objects to picked while the issue with the conveyor is being addressed, etc.

The inventors have recognized and appreciated that it may be beneficial to store information about the conveyor and/or object travel velocity determined in accordance with techniques described herein in a log or other storage architecture to improve metric tracking regarding the pick rate of the mobile robot. For instance, a human worker may have intentionally set a conveyor speed at a slower speed than expected to ensure that a human worker unloading boxes from a distal end of the conveyor (e.g., the end of the conveyor opposite where the boxes are placed on the conveyor) has sufficient time to perform the unloading. Logging information about the detected slower than expected speed of the conveyor may be useful in determining that the slower than expected pick rate of the mobile robot was due to the slow conveyor speed rather than the operation of the robot. Additionally, logging information about the state of objects on the conveyor (e.g., information about the number of stuck boxes and/or their location) may be useful to facilitate maintenance and/or replacement of faulty conveyors.

Although image data is described herein as being used for position and velocity estimation of objects on a conveyor, it should be appreciated that other sensor data additionally or alternatively may be used to estimate position and/or velocity information (or other information, such as object pose) of objects on a conveyor. For example, a robot having one or more onboard sensors configured to sense radar data, ultrasonic data, point laser rangefinder data, visible or infrared depth sensor data (e.g., LIDAR, stereo camera, direct time of flight sensor data, flash LIDAR, indirect time-of-flight sensor data, structured light sensor data), or configured to sense any other suitable type of sensor data may be used for position and/or velocity estimation of one or more objects on a conveyor using one or more of the techniques described herein. In embodiments that include visible or infrared depth sensors, such sensor data may be used to determine 6 degree of freedom pose estimation, optic flow of objects for estimating their velocity on the conveyor, or differentiation for estimating object velocity.

In some embodiments, one or more off-robot sensors may be used to sense data about objects on a conveyor coupled to a mobile robot that may be used to estimate the position and/or velocity of the objects using one or more the techniques described herein. For instance, a count-based technology that counts objects as they move away from the robot may be used. Non-limiting examples of count-based technologies include scan tunnels, barcode readers, beam break sensors, weight sensors, off-robot LIDAR, ultrasonic sensors, and capacitive sensors. In some embodiments, the one or more off-robot sensors may include sensors that estimate the presence of objects in free space. Non-limiting example of free space sensors include radar, cameras with different perspectives than from on-robot camera modules, weight sensors, LIDAR, ultrasonic sensors, and capacitive sensors. In some embodiments, the one or more off-robot sensors may include velocity sensors integrated with the conveyor. Non-limiting examples of integrated velocity sensors include conveyor belt speed sensors, roller speed sensors, and observable patterns on conveyor belts/rollers that can be used to assist in detection of the motion/speed of the conveyor.

In some embodiments, one or more mirrors or reflectors may be used to enable observation of objects on the conveyor from perspectives other than the perspective of the mobile robot placing objects on the conveyor. For instance, such mirrors or reflectors may be used to estimate the pose of an object in a manner similar to a stereo or multi-camera but using a single 2D (e.g., RGB) sensor. In some instances, the use of mirrors or reflectors may reduce the optional for occlusions by the robot, objects on the conveyor, or other infrastructure. For example, if a tall box is located on the conveyor near the mobile robot, the tall box may block the presence of shorter boxes located on the conveyor behind the tall box. Use of one or more mirrors may enable the detection of such occluded objects.

Additionally, although the example provided herein is to use a trained machine learning model to segment an image into “object” pixels and “non-object” pixels, it should be appreciated that a machine learning model used in accordance to process one or more images may be trained to perform one or more of pose estimation, velocity estimation, image pose estimation, or depth estimation (e.g., to approximate a depth sensor). Additionally, some embodiments may be configured to process image data using techniques other than using a machine learning model. For example, some embodiments may be configured to process image data using one or more of image differentiation/change detection, optic flow to estimate image velocity, or velocity estimation of the conveyor belt or rollers themselves.

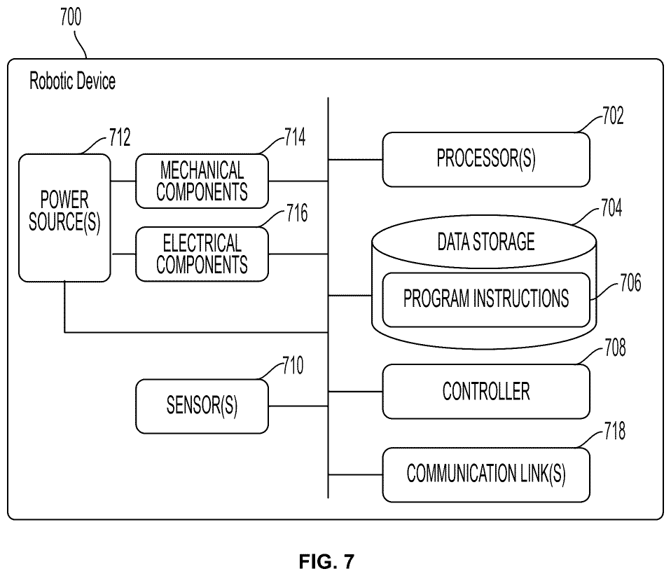

FIG. 7 illustrates an example configuration of a robotic device (or “robot”) 700, according to an illustrative embodiment of the invention. The robotic device 700 represents an example robotic device configured to perform the operations described herein. Additionally, the robotic device 700 may be configured to operate autonomously, semi-autonomously, and/or using directions provided by user(s), and may exist in various forms, such as a humanoid robot, biped, quadruped, or other mobile robot, among other examples. Furthermore, the robotic device 700 may also be referred to as a robotic system, mobile robot, or robot, among other designations.

As shown in FIG. 7, the robotic device 700 includes processor(s) 702, data storage 704, program instructions 706, controller 708, sensor(s) 710, power source(s) 712, mechanical components 714, and electrical components 716. The robotic device 700 is shown for illustration purposes and may include more or fewer components without departing from the scope of the disclosure herein. The various components of robotic device 700 may be connected in any manner, including via electronic communication means, e.g., wired or wireless connections. Further, in some examples, components of the robotic device 700 may be positioned on multiple distinct physical entities rather on a single physical entity. Other example illustrations of robotic device 700 may exist as well.

Processor(s) 702 may operate as one or more general-purpose processor or special purpose processors (e.g., digital signal processors, application specific integrated circuits, etc.). The processor(s) 702 can be configured to execute computer-readable program instructions 706 that are stored in the data storage 704 and are executable to provide the operations of the robotic device 700 described herein. For instance, the program instructions 706 may be executable to provide operations of controller 708, where the controller 708 may be configured to cause activation and/or deactivation of the mechanical components 714 and the electrical components 716. The processor(s) 702 may operate and enable the robotic device 700 to perform various functions, including the functions described herein.

The data storage 704 may exist as various types of storage media, such as a memory. For example, the data storage 704 may include or take the form of one or more computer-readable storage media that can be read or accessed by processor(s) 702. The one or more computer-readable storage media can include volatile and/or non-volatile storage components, such as optical, magnetic, organic or other memory or disc storage, which can be integrated in whole or in part with processor(s) 702. In some implementations, the data storage 704 can be implemented using a single physical device (e.g., one optical, magnetic, organic or other memory or disc storage unit), while in other implementations, the data storage 704 can be implemented using two or more physical devices, which may communicate electronically (e.g., via wired or wireless communication). Further, in addition to the computer-readable program instructions 706, the data storage 704 may include additional data such as diagnostic data, among other possibilities.

The robotic device 700 may include at least one controller 708, which may interface with the robotic device 700. The controller 708 may serve as a link between portions of the robotic device 700, such as a link between mechanical components 714 and/or electrical components 716. In some instances, the controller 708 may serve as an interface between the robotic device 700 and another computing device. Furthermore, the controller 708 may serve as an interface between the robotic device 700 and a user(s). The controller 708 may include various components for communicating with the robotic device 700, including one or more joysticks or buttons, among other features. The controller 708 may perform other operations for the robotic device 700 as well. Other examples of controllers may exist as well.

Additionally, the robotic device 700 includes one or more sensor(s) 710 such as force sensors, proximity sensors, motion sensors, load sensors, position sensors, touch sensors, depth sensors, ultrasonic range sensors, and/or infrared sensors, among other possibilities. The sensor(s) 710 may provide sensor data to the processor(s) 702 to allow for appropriate interaction of the robotic device 700 with the environment as well as monitoring of operation of the systems of the robotic device 700. The sensor data may be used in evaluation of various factors for activation and deactivation of mechanical components 714 and electrical components 716 by controller 708 and/or a computing system of the robotic device 700.

The sensor(s) 710 may provide information indicative of the environment of the robotic device for the controller 708 and/or computing system to use to determine operations for the robotic device 700. For example, the sensor(s) 710 may capture data corresponding to the terrain of the environment or location of nearby objects, which may assist with environment recognition and navigation, etc. In an example configuration, the robotic device 700 may include a sensor system that may include a camera, RADAR, LIDAR, time-of-flight camera, global positioning system (GPS) transceiver, and/or other sensors for capturing information of the environment of the robotic device 700. The sensor(s) 710 may monitor the environment in real-time and detect obstacles, elements of the terrain, weather conditions, temperature, and/or other parameters of the environment for the robotic device 700.

Further, the robotic device 700 may include other sensor(s) 710 configured to receive information indicative of the state of the robotic device 700, including sensor(s) 710 that may monitor the state of the various components of the robotic device 700. The sensor(s) 710 may measure activity of systems of the robotic device 700 and receive information based on the operation of the various features of the robotic device 700, such the operation of extendable legs, arms, or other mechanical and/or electrical features of the robotic device 700. The sensor data provided by the sensors may enable the computing system of the robotic device 700 to determine errors in operation as well as monitor overall functioning of components of the robotic device 700.

For example, the computing system may use sensor data to determine the stability of the robotic device 700 during operations as well as measurements related to power levels, communication activities, components that require repair, among other information. As an example configuration, the robotic device 700 may include gyroscope(s), accelerometer(s), and/or other possible sensors to provide sensor data relating to the state of operation of the robotic device. Further, sensor(s) 710 may also monitor the current state of a function that the robotic device 700 may currently be operating. Additionally, the sensor(s) 710 may measure a distance between a given robotic limb of a robotic device and a center of mass of the robotic device. Other example uses for the sensor(s) 710 may exist as well.

Additionally, the robotic device 700 may also include one or more power source(s) 712 configured to supply power to various components of the robotic device 700. Among possible power systems, the robotic device 700 may include a hydraulic system, electrical system, batteries, and/or other types of power systems. As an example illustration, the robotic device 700 may include one or more batteries configured to provide power to components via a wired and/or wireless connection. Within examples, components of the mechanical components 714 and electrical components 716 may each connect to a different power source or may be powered by the same power source. Components of the robotic device 700 may connect to multiple power sources as well.

Within example configurations, any type of power source may be used to power the robotic device 700, such as a gasoline and/or electric engine. Further, the power source(s) 712 may charge using various types of charging, such as wired connections to an outside power source, wireless charging, combustion, or other examples. Other configurations may also be possible. Additionally, the robotic device 700 may include a hydraulic system configured to provide power to the mechanical components 714 using fluid power. Components of the robotic device 700 may operate based on hydraulic fluid being transmitted throughout the hydraulic system to various hydraulic motors and hydraulic cylinders, for example. The hydraulic system of the robotic device 700 may transfer a large amount of power through small tubes, flexible hoses, or other links between components of the robotic device 700. Other power sources may be included within the robotic device 700.

Mechanical components 714 can represent hardware of the robotic device 700 that may enable the robotic device 700 to operate and perform physical functions. As a few examples, the robotic device 700 may include actuator(s), extendable leg(s), arm(s), wheel(s), one or multiple structured bodies for housing the computing system or other components, and/or other mechanical components. The mechanical components 714 may depend on the design of the robotic device 700 and may also be based on the functions and/or tasks the robotic device 700 may be configured to perform. As such, depending on the operation and functions of the robotic device 700, different mechanical components 714 may be available for the robotic device 700 to utilize. In some examples, the robotic device 700 may be configured to add and/or remove mechanical components 714, which may involve assistance from a user and/or other robotic device.

The electrical components 716 may include various components capable of processing, transferring, providing electrical charge or electric signals, for example. Among possible examples, the electrical components 716 may include electrical wires, circuitry, and/or wireless communication transmitters and receivers to enable operations of the robotic device 700. The electrical components 716 may interwork with the mechanical components 714 to enable the robotic device 700 to perform various operations. The electrical components 716 may be configured to provide power from the power source(s) 712 to the various mechanical components 714, for example. Further, the robotic device 700 may include electric motors. Other examples of electrical components 716 may exist as well.

In some implementations, the robotic device 700 may also include communication link(s) 718 configured to send and/or receive information. The communication link(s) 718 may transmit data indicating the state of the various components of the robotic device 700. For example, information read in by sensor(s) 710 may be transmitted via the communication link(s) 718 to a separate device. Other diagnostic information indicating the integrity or health of the power source(s) 712, mechanical components 714, electrical components 716, processor(s) 702, data storage 704, and/or controller 708 may be transmitted via the communication link(s) 718 to an external communication device.

In some implementations, the robotic device 700 may receive information at the communication link(s) 718 that is processed by the processor(s) 702. The received information may indicate data that is accessible by the processor(s) 702 during execution of the program instructions 706, for example. Further, the received information may change aspects of the controller 708 that may affect the behavior of the mechanical components 714 or the electrical components 716. In some cases, the received information indicates a query requesting a particular piece of information (e.g., the operational state of one or more of the components of the robotic device 700), and the processor(s) 702 may subsequently transmit that particular piece of information back out the communication link(s) 718.

In some cases, the communication link(s) 718 include a wired connection. The robotic device 700 may include one or more ports to interface the communication link(s) 718 to an external device. The communication link(s) 718 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

A number of implementations have been described. Nevertheless, it will be understood that various modifications may be made without departing from the spirit and scope of the disclosure.

1. A method, comprising:
receiving first image data, the first image data including a first representation of a first object and a conveyor, the first image data captured at a first time; and
determining by at least one hardware processor, a velocity of the conveyor based, at least in part, on the first representation of the first object in the first image data and a difference between the first time and a second time different from the first time.

2. The method of claim 1, wherein the second time is a time at which the first object was placed on the conveyor.

3. The method of claim 1, further comprising receiving second image data, the second image data including a second representation of the first object and the conveyor, the second image data captured at the second time, wherein determining the velocity of the conveyor is further based, at least in part, on the second representation of the first object in the second image data.

4. The method of claim 3, wherein
the first image data includes first 2D image data and first time-of-flight data,
the second image data includes second 2D image data and second time-of-flight data, and
the method further comprises
processing the first 2D image data to identify a first mask for the first representation of the first object;
determining a first 3D geometry of the first object based on the first mask and the first time-of-flight data;
processing the second 2D image data to identify a second mask for the second representation of the first object; and
determining a second 3D geometry of the first object based on the second mask and the second time-of-flight data,
wherein determining a velocity of the conveyor based, at least in part, on the first representation of the first object in the first image data, the second representation of the first object in the second image data, and a difference between the first time and the second time comprises determining the velocity of the conveyor based on the first 3D geometry of the first object and the second 3D geometry of the first object.

5. The method of claim 3, further comprising:
determining based, at least in part, on the first image data, a first location of the first object at the first time;
determining based, at least in part, on the second image data, a second location of the first object at the second time; and
determining the velocity of the conveyor based, at least in part, on the first location, the second location and the difference between the first time and the second time.

6. The method of claim 3, wherein the first image data is captured from a first camera and the second image data is captured from a second camera having a different field of view from the first camera.

7. The method of claim 3, wherein an arm of a mobile robot coupled to the conveyor is not included in the first image data or the second image data.

8. The method of claim 1, wherein
the first image data further includes a first representation of a second object, and
determining the velocity of the conveyor is further based, at least in part, on the first representation of the second object in the first image data.

9. The method of claim 1, further comprising:
controlling a mobile robot coupled to the conveyor to perform an action based, at least in part, on the velocity of the conveyor.

10. The method of claim 9, wherein controlling a mobile robot to perform an action comprises controlling the mobile robot to adjust an operation speed of the mobile robot.

11. The method of claim 10, wherein controlling the mobile robot to adjust an operation speed of the mobile robot comprises controlling the mobile robot to adjust a rate at which the mobile robot is placing objects on the conveyor.

12. The method of claim 10, wherein controlling the mobile robot to adjust an operation speed of the mobile robot comprises halting operation of an arm of the mobile robot when it is determined that the velocity of the conveyor is zero.

13. The method of claim 9, wherein controlling a mobile robot to perform an action comprises controlling the mobile robot to place an object at a particular place on the conveyor.

14. The method of claim 9, wherein controlling a mobile robot to perform an action comprises controlling the mobile robot to place an object on the conveyor using a particular orientation.

15. The method of claim 9, wherein controlling a mobile robot to perform an action comprises controlling the mobile robot to grasp a particular object.

16. The method of claim 9, wherein controlling a mobile robot to perform an action comprises controlling the mobile robot to output an indication of the velocity of the conveyor.

17. The method of claim 9, wherein controlling a mobile robot to perform an action comprises controlling the mobile robot to interact with the first object.

18. The method of claim 1, wherein the first object is a box located on the conveyor.

19. A mobile robot, comprising:
at least one hardware processor configured to:
receive first image data, the first image data including a first representation of a first object and a conveyor, the first image data captured at a first time; and
determine a velocity of the conveyor based, at least in part, on the first representation of the first object in the first image data and a difference between the first time and a second time different from the first time.

20. A non-transitory computer-readable medium including a plurality of processor executable instructions stored thereon that, when executed by at least one hardware processor, perform a method, the method comprising:
receiving first image data, the first image data including a first representation of a first object and a conveyor, the first image data captured at a first time; and
determining by at least one hardware processor, a velocity of the conveyor based, at least in part, on the first representation of the first object in the first image data and a difference between the first time and a second time different from the first time.
